(19) United States
(12) Patent Application Publication
(10) Pub. No.: US 2026/0135180 A1
(43) Pub. Date: May 14, 2026

(54) SEPARATION OF METALS FROM LITHIUM-ION BATTERY MATERIALS

(71) Applicant: UCHICAGO ARGONNE, LLC, Chicago, IL (US)

(72) Inventors: Trevor L. DZWINIEL, Carol Stream, IL (US); Ayorinde Emmanuel AJIBOYE, Kwara State (NG)

(73) Assignee: UCHICAGO ARGONNE, LLC, Chicago, IL (US)

(21) Appl. No.: 19/319,514

(22) Filed: Sep. 4, 2025

Related U.S. Application Data
(60) Provisional application No. 63/718,354, filed on Nov. 8, 2024.

(51) Int. Cl. H01M 10/54; B09B 3/80; B09B 101/16

(52) U.S. Cl. CPC H01M 10/54; B09B 3/80; B09B 2101/16

(57) ABSTRACT

A method for separating metals from a battery material includes contacting the battery material with a first acid, forming a first solution comprising lithium from the battery material in the first acid; separating remaining battery material from the first solution; contacting the remaining battery material with a second acid, forming a second solution comprising a metal from the remaining battery material; contacting the second solution with a metal-selective extractant in a non-polar solvent, forming a first non-polar phase comprising the metal, the metal-selective extractant, and the non-polar solvent; and separating the first non-polar phase from the second solution via a membrane.

### CROSS-REFERENCE TO RELATED APPLICATIONS

This application claims priority to and the benefit of U.S. Provisional Patent App. No. 63/718,354, filed Nov. 8, 2024, the contents of which is incorporated herein by reference in its entirety.

### GOVERNMENT RIGHTS

This invention was made with government support under Contract No. DE-AC02-06CH11357 awarded by the United States Department of Energy to UChicago Argonne, LLC, operator of Argonne National Laboratory. The government has certain rights in the invention.

### FIELD

The present technology is generally related to separating metals from mixed metal waste materials. In particular, the present technology relates to separating metals from spent lithium-ion battery materials.

### BACKGROUND

Conventional industrial metal production processes typically utilize mixer-settlers to extract desired metals from digested samples, such as ores or recycled materials. These systems are commonly employed for the purification of metals like copper, nickel, cobalt, uranium, and lanthanides. However, these methods can be time-consuming and costly, particularly at larger scales. Furthermore, the efficiency of extraction in mixer-settlers is influenced by the size of the settlers and can be adversely affected by solvent losses and entrainment in the sample.

### SUMMARY

In an aspect, a method of separating metals from a battery material is disclosed. The method includes contacting the battery material with a first acid, forming a first solution comprising lithium from the battery material in the first acid; separating remaining battery material from the first solution; contacting the remaining battery material with a second acid, forming a second solution comprising a metal from the remaining battery material, the second solution having a pH of about 0 to about 3; contacting the second solution with a metal-selective extractant in a non-polar solvent, forming a first non-polar phase comprising the metal, the metal-selective extractant, and the non-polar solvent; and separating the first non-polar phase from the second solution via a membrane.

The metal may include copper; the second solution may have a pH of about 0 to about 3; the metal-selective extractant may include a copper-selective extractant, the copper-selective extractant may include 2-hydroxy-5-nonylacetophenone oxime, 2-hydroxy-5-nonylacetophenone ketoxime, 5-nonylsalicylaldoxime, or a combination of two or more thereof; and the method may further include contacting the first non-polar phase with an acid, forming a copper salt solution.

The second solution may include manganese, and the method may further include contacting the second solution with a manganese-selective extractant in the non-polar solvent, forming a second non-polar phase comprising manganese, the manganese-selective extractant, and the non-polar solvent; and separating the second solution from the second non-polar phase. The method may further include contacting the second non-polar phase with an acid, forming an aqueous manganese salt solution. The manganese-selective extractant may include di(2-ethylhexyl)phosphoric acid sulfanyl-sulfanylidene-bis[(2R)-2,4,4-trimethylpentyl]-λ⁵-phosphane, or a combination thereof.

The second solution may include cobalt, and the method may further include contacting the second solution with a cobalt-selective extractant in the non-polar solvent, forming a third non-polar phase comprising cobalt, the cobalt-selective extractant, and the non-polar solvent; and separating the second solution from the third non-polar phase. The method may further include contacting the third non-polar phase with an acid to form an aqueous cobalt salt solution. The cobalt-selective extractant may include a saponified bis(2,4,4-trimethylpentyl)phosphinic acid.

The second solution may include nickel, and the method may further include adding a base to the second solution to increase pH of the second solution to about 5 to about 6.5; contacting the second solution with a nickel-selective extractant in the non-polar solvent, forming a fourth non-polar phase comprising copper and the non-polar solvent; and separating the second solution from the fourth non-polar phase. The method may further include contacting the fourth non-polar phase with an acid to form an aqueous nickel salt solution.

The first solution may include lithium, and the method may further include contacting the first solution with a lithium-selective extractant in the non-polar solvent, forming a fifth non-polar phase comprising lithium and the non-polar solvent; and separating the first solution from the fifth non-polar phase. The method may further include contacting the fifth non-polar phase with an acid, forming a lithium salt solution.

The second solution may further include cobalt, and the method may further include contacting the second solution with a cobalt-selective extractant in the non-polar solvent, forming a second non-polar phase comprising cobalt and the non-polar solvent; and separating the second solution from the second non-polar phase. The method may include contacting the second non-polar phase with an acid, forming a cobalt salt solution.

The first acid may include oxalic acid. The second acid may include sulfuric acid, hydrochloric acid, nitric acid, or a combination of any two or more thereof. The non-polar solvent may include kerosene, dichloromethane, heptane, toluene, hexane, octane, cyclohexanone, cyclohexane, or a combination of two or more thereof.

The copper-selective extractant may include 2-hydroxy-5-nonylacetophenone oxime, 2-hydroxy-5-nonylacetophenone ketoxime, 5-nonylsalicylaldoxime, or a combination of two or more thereof.

The membrane may include a hydrophobic microporous membrane or a hydrophilic microporous membrane, and the membrane may include polytetrafluoroethylene membrane (PTFE), polyvinylidene fluoride (PVDF), sulfonated tetrafluoroethylene based fluoropolymer-copolymer, or ceramic. The battery material may include at least a portion of a battery casing, at least a portion of a battery current collector, at least a portion of a battery separator, at least a portion of an anode material, at least a portion of a cathode material, or a combination of any two or more thereof from a spent lithium-ion battery.

In another aspect, a method of separating metals from a spent lithium-ion battery material is disclosed. The method includes dissolving lithium from the spent lithium-ion battery material in oxalic acid to form a first aqueous solution; extracting lithium from the first aqueous solution into a first non-polar phase; dissolving copper, manganese, cobalt, and nickel from the spent lithium-ion battery material in sulfuric acid to form a second aqueous solution; extracting copper from the second aqueous solution into a second non-polar phase; extracting manganese from the second aqueous solution into a third non-polar phase; extracting cobalt from the second aqueous solution into a fourth non-polar phase; and increasing pH of the second aqueous solution to about 5 to about 6.5, extracting the nickel from the second aqueous solution into a fifth non-polar phase.

### BRIEF DESCRIPTION OF THE DRAWINGS

FIG. 1 is a flow diagram of a process for separating metals from lithium-ion battery materials.

FIG. 2 is an illustration of schematic of a membrane separation system used to separate metals from lithium-ion battery materials.

FIG. 3 is an illustration of a schematic of a counterflow membrane separation system used to separate metals from lithium-ion battery materials.

FIG. 4A is a graph of selective copper recovery from a lithium-ion battery material solution using a copper extractant.

FIG. 4B is a graph of pH-dependent selective manganese recovery from a lithium-ion battery material solution using a manganese extractant.

FIG. 4C is a graph of pH-dependent cobalt recovery from a lithium-ion battery material solution using a cobalt extractant.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

As used herein, “battery material” includes, but is not limited to, material used as battery casing (e.g., steel, aluminum, hard plastic), material used as a battery current collector (e.g., copper, aluminum), material used as a battery separator (e.g., polymer, glass fiber, ceramic), material used as an anode (e.g., lithium, conductive carbon, silicon), material used as a cathode (e.g., LiFePO₄, LiCoO₂, LiNiO₂, LiNi₁₋ₓCo_{y}M⁴₂O₂, LiMn_{0.5}Ni_{0.5}O₂, LiMn_{1/3}Co_{1/3}Ni_{1/3}O₂, LiMn₂O₄, LiCr_{0.5}Mn_{1.5}O₄, LiCrMnO₄, LiFc_{0.5}Mn_{1.5}O₄, LiCo_{0.5}Mn_{1.5}O₄, LiCoMnO₄, LiCoMnO₄, LiNi_{0.5}Mn_{1.5}O₄, LiNiPO₄, LiCoPO₄, LiMnPO₄, LiCoPO₄F, Li₂MnO₃, Li₅FeO₄, LiFeO₂, LiM⁴_{0.5}Mn_{1.5}O₄, Li_{1+x″}Ni_{α}Mn_{β}Co_{γ}M⁵_{δ′}O_{2-z″}F_{z″}, or VO₂, where M⁴ is Al, Mg, Ti, B, Ga, Si, Mn, or Co; M⁵ is Mg, Zn, Al, Ga, B, Zr, or Ti; A is Li, Ag, Cu, Na, Mn, Fe, Co, Ni, Cu, or Zn; 0≤x≤0.3; 0≤y≤0.5; 0<z≤0.5; 0<x″≤0.4; 0≤α≤1; 0≤β≤1; 0≤γ≤1; 0≤δ′≤0.4; and 0≤z″≤0.4; with the proviso that at least one of α, β and γ is greater than 0), or a combination of any two or more thereof. The battery material may be sourced from a lithium-ion battery. The lithium-ion battery may be a spent lithium-ion battery.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

Disclosed herein are methods and systems for the sequential recovery of constituent elements from leached liquor of processed lithium-ion batteries. The methods and systems include continuous multi-stage extraction of constituent elements using liquid-liquid extraction. These liquid-liquid extraction processes are cost-effective, environmentally friendly, and can be scaled to accommodate recycling of large feeds and yield high purity products.

Spent lithium-ion batteries generate tons of waste. Recycling of the critical metals from this waste will be useful to meet demand, use resources efficiently, bolster supply chains, and safeguard the environment. Conventional processes for recycling lithium-ion batteries have faced serious drawbacks due to loss of lithium (e.g., >20%) and other metals, increased amounts of impurities in the resulting products, and high cost, among other things.

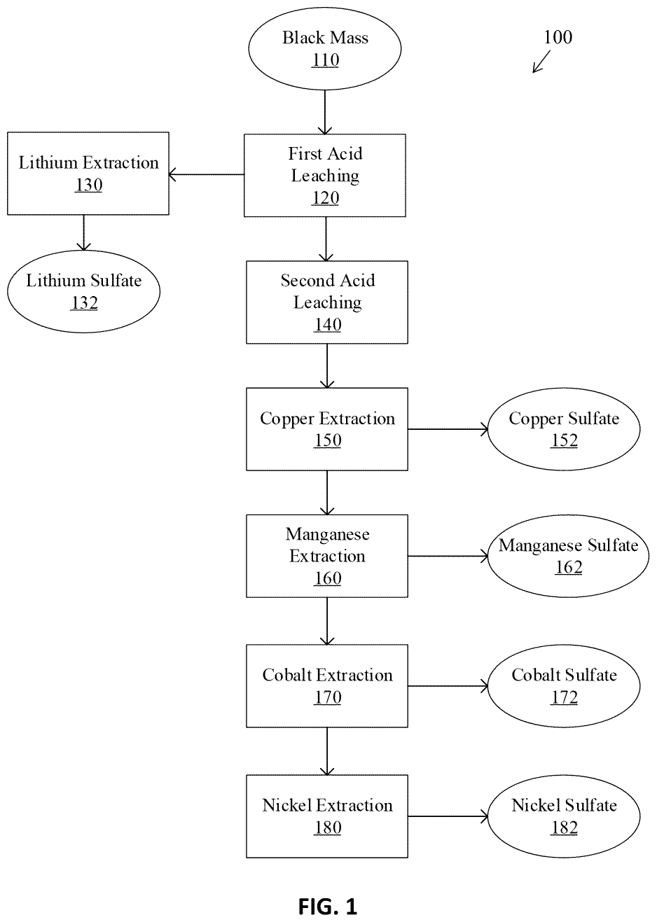

FIG. 1 is an illustration of a schematic of a process 100 for separating metals from lithium-ion battery materials. The lithium-ion battery materials may be preprocessed to form a black mass 110. The black mass 110 may include at least a portion of a battery casing, at least a portion of a battery current collector, at least a portion of a battery separator, at least a portion of an anode material, at least a portion of a cathode material, or a combination of any two or more thereof from a lithium-ion battery (e.g., a spent lithium-ion battery). In any embodiments, the black mass may be prepared, for example, by shredding spent lithium-ion batteries and mechanically separating to remove binders, electrolytes, plastics, and steel, resulting in the black mass including cathode materials and anode materials. The black mass 110 may be further preprocessed with optional heat treatment. Depending on the type of lithium-ion battery, the black mass 110 may include lithium, cobalt, nickel, manganese, copper, or a combination of any two or more thereof.

In step 120, the black mass 110 is leached with a first acid solution. In step 120, lithium is dissolved in the first acid solution, forming a lithium leach solution. The amount of lithium from the black mass 110 dissolved in the lithium leach solution may be about 50 wt. % to about 100 wt. % of the total lithium in the black mass (e.g., about 70 wt. % to about 99 wt. %, about 80 wt. % to about 98 wt. %, about 90 wt. % to about 95 wt. %, or about 95 wt. %). In step 120, aluminum present in the black mass 110 may also be dissolved in the first acid solution. The amount of aluminum from the black mass 110 dissolved in the lithium leach solution may be about 50 wt. % to about 100 wt. % of the total aluminum in the black mass (e.g., about 70 wt. % to about 100 wt. %, about 80 wt. % to about 100 wt. %, about 90 wt. % to about 100 wt. %, or about 99 wt. %). In step 120, iron present in the black mass 110 may also be partially dissolved in the first acid solution. The amount of iron from the black mass 110 dissolved in the lithium leach solution may be about 0.1 wt. % to about 10 wt. % of the total iron in the black mass 110 (e.g., about 1 wt. % to about 10 wt. %, about 5 wt. % to about 10 wt. %, or about 10 wt. %). In step 120, manganese present in the black mass 110 may also be partially dissolved in the first acid solution. The amount of manganese from the black mass 110 dissolved in the lithium leach solution may be about 0.1 wt. % to about 10 wt. % of the total manganese in the black mass 110 (e.g., about 1 wt. % to about 10 wt. %, about 5 wt. % to about 10 wt. %, or about 10 wt. %).

The remaining battery materials in the black mass 110 may not be dissolved in the first acid solution, remaining solid. The lithium leach solution may be separated from the remaining black mass solid (e.g., via filtering).

The acid in the first acid solution may be oxalic acid (C₂H₂O₄, CAS No. 144-62-7). The concentration of the acid may be about 0.5 M to about 1.0 M (e.g., about 0.8 M to about 1.0 M, or about 1.0 M). The first acid solution may be heated to a temperature of about 20° C. to about 95° C. (e.g., about 40° C. to about 90° C., about 50° C. to about 90° C., about 60° C. to about 90° C., about 70° C. to about 90° C., about 80° C. to about 90° C., or about 85° C.). The first acid solution may be in contact with the black mass while heated for a sufficient time to strip a substantial amount of the metals from the black mass and dissolve the metals into the first acid solution (e.g., about 1 minute, 10 minutes, 30 minutes, 60 minutes, 2 hours, 5 hours, 10 hours, 24 hours, 48 hours, or longer).

After step 120, at least a portion of the first acid solution may be reused for additional leaching steps. For example, the acid in the first acid solution may be oxalic acid, and the lithium leach solution may be cooled at a temperature of about 1° C. to about 10° C. (e.g., about 5° C.) to form solid oxalate crystals that may be filtered from the lithium leach solution and reused in additional leaching steps.

In step 130, the lithium leach solution is contacted with a lithium-selective extractant to strip the lithium from the lithium leach solution. The lithium-selective extractant is dissolved in a non-polar solvent and the lithium leach solution is aqueous. Thus, when the lithium leach solution is contacted with the lithium-selective extractant in the non-polar solvent, lithium ions from the lithium leach solution move into the non-polar phase.

The lithium-selective extractant may include a phosphorus-based extractant (e.g., Cyanex 936P), a mixture of 1,6-hexanediamine-N,N,N′,N′-tetraacetic acid and trioctylphosphine oxide, or a combination of any two or more thereof. Nonlimiting examples of the non-polar solvent may include kerosene, dichloromethane, toluene, heptane, hexane, octane, cyclohexanone, cyclohexane, or a combination of two or more thereof. For example, the lithium-selective extractant may be about 20% v/v Cyanex 936P in kerosene.

The non-polar phase, including the lithium-selective extractant, lithium ions, and non-polar solvent, may be separated from the lithium leach solution. Separation may be conducted via membrane separation, separatory funnel, or a mixer/settler. In any embodiment, membrane separation may be used to separate the non-polar and polar phases, as disclosed herein.

After extracting the lithium into the non-polar phase, the non-polar phase may be treated with another acid solution (e.g., sulfuric acid, hydrochloric acid, or nitric acid) forming a lithium salt dissolved in the acid. The purity of lithium in the lithium salt solution as compared to other metals in the lithium salt solution may be about 50 wt. % to about 100 wt. % (e.g., about 70 wt. % to about 99 wt. %, about 80 wt. % to about 99 wt. %, about 90 wt. % to about 99 wt. %, or about 98 wt. %). For example, the acid may be sulfuric acid forming a lithium sulfate solution.

In step 140, solids from the black mass 110 remaining after step 120 are leached with a second acid solution. Prior to leaching, the black mass 110 may be washed with a polar solvent (e.g., water) to remove or substantially reduce traces of the first acid solution.

In step 140, copper, manganese, cobalt, and nickel in the black mass 110 are dissolved in the second acid solution, forming a mixed metal leach solution. There may be battery materials in the black mass 110 that do not dissolve in the second acid, remaining as a black mass solid. For example, conductive carbon may not dissolve in the second acid solution. The leach solution may be separated from the remaining black mass solid (e.g., via filtering), forming the liquid mixed metal leach solution.

The acid in the second acid solution may include sulfuric acid, hydrochloric acid, citric acid, nitric acid, or a combination thereof. The concentration of the second acid may be about 0.5 M to about 2.0 M (e.g., about 0.5 M to about 1.0 M, about 0.8 M to about 1.2 M, or about 1.0 M). The pH of the leach solution may be about-0.3 to about 3. While in contact with the black mass, the second acid solution may be heated to a temperature of about 20° C. to about 95° C. (e.g., about 40° C. to about 90° C., about 50° C. to about 90° C., about 60° C. to about 90° C., about 70° C. to about 90° C., about 80° C. to about 90° C., or about 85° C.). The second acid solution may be in contact with the black mass while heated for a sufficient time to strip a substantial amount of the metals from the black mass and dissolve them into the second acid solution (e.g., about 1 minute, 10 minutes, 30 minutes, 60 minutes, 2 hours, 5 hours, 10 hours, 24 hours, 48 hours, or longer).

In step 150, the resulting mixed metal leach solution is contacted with a copper-selective extractant to extract copper from the leach solution. Prior to step 150, the pH of the leach solution may be adjusted to about 0 to about 2.5 (e.g., about 1 to about 2.5, about 2 to about 2.5, about 2.2 to about 2.5, or about 2.5) using addition of a base (e.g., about 0.5 M to about 1.0 M NaOH). The copper-selective extractant may be dissolved or dispersed in a non-polar solvent phase and the leach solution may be an aqueous phase. Thus, when the leach solution is contacted with the copper-selective extractant in the non-polar solvent, copper ions from the aqueous leach solution phase move into the non-polar phase.

The amount of copper from the leach solution moved to the non-polar phase may be about 50 wt. % to about 100 wt. % of the total copper in the leach solution (e.g., about 70 wt. % to about 100 wt. %, about 80 wt. % to about 98 wt. %, about 90 wt. % to about 95 wt. %, or about 95 wt. %). After this step, the leach solution may be substantially free of copper (e.g., less than about 10 wt. %, less than about 5 wt. %, less than about 2 wt. %, less than about 1 wt. %, less than about 0.5 wt. %, less than about 0.1 wt. %, or less than about 0.01 wt. %).

The copper-selective extractant may include 2-hydroxy-5-nonylacetophenone oxime (LIX84), 2-hydroxy-5-nonylacetophenone ketoxime, 5-nonylsalicylaldoxime, or a combination of two or more thereof. Nonlimiting examples of the non-polar solvent may include kerosene, dichloromethane, toluene, heptane, hexane, octane, cyclohexanone, cyclohexane, or a combination of two or more thereof. For example, the copper-selective extractant may be 2% v/v LIX84 in kerosene.

After extraction, the non-polar phase, including the copper-selective extractant, copper ions, and non-polar solvent, may be separated from the leach solution. Separation may be conducted via membrane separation, separatory funnel, or a mixer/settler. In any embodiment, membrane separation may be used to separate the non-polar and polar phases, as disclosed herein.

After extracting the copper into the non-polar phase, the non-polar phase may be contacted with an acid solution (e.g., sulfuric acid, hydrochloric acid, nitric acid, or a combination thereof), forming a copper salt dissolved in the acid. The purity of copper salt in the copper salt solution relative to other metals in the copper salt solution may be about 50 wt. % to about 100 wt. % of the total copper in the leach solution (e.g., about 70 wt. % to about 99 wt. %, about 80 wt. % to about 99 wt. %, about 90 wt. % to about 99 wt. %, or about 99 wt. %). For example, the acid may be sulfuric acid forming a copper sulfate solution.

In step 160, the leach solution is contacted with a manganese-selective extractant to extract manganese from the leach solution. The manganese-selective extractant may be dissolved or dispersed in a non-polar solvent and the leach solution is in an aqueous phase. Thus, when the leach solution is contacted with the manganese-selective extractant in the non-polar solvent, manganese ions from the leach solution move into the non-polar phase.

The amount of manganese from the leach solution moved to the non-polar phase may be about 50 wt. % to about 100 wt. % of the total manganese in the leach solution (e.g., about 70 wt. % to about 99 wt. %, about 80 wt. % to about 98 wt. %, about 90 wt. % to about 95 wt. %, or about 95 wt. %). After this step, the leach solution may be substantially free of manganese (e.g., less than about 10 wt. %, less than about 5 wt. %, less than about 2 wt. %, less than about 1 wt. %, less than about 0.5 wt. %, less than about 0.1 wt. %, or less than about 0.01 wt. %).

The manganese-selective extractant may include di(2-ethylhexyl)phosphoric acid, sulfanyl-sulfanylidene-bis[(2R)-2,4,4-trimethylpentyl]-25-phosphane, or a combination of two or more thereof. Nonlimiting examples of the non-polar solvent may include kerosene, dichloromethane, toluene, heptane, hexane, octane, cyclohexanone, cyclohexane, or a combination of two or more thereof. For example, the manganese-selective extractant may be 10% v/v di(2-ethylhexyl)phosphoric acid in kerosene.

Following extraction, the non-polar phase, including the manganese-selective extractant, manganese ions, and non-polar solvent, may be separated from the leach solution. Separation may be conducted via membrane separation, separatory funnel, or a mixer/settler. In any embodiment, membrane separation may be used to separate the non-polar and aqueous phases, as disclosed herein.

After extracting the manganese into the non-polar phase, the non-polar phase may be contacted with an acid solution (e.g., sulfuric acid, hydrochloric acid, nitric acid, or a combination thereof), forming a manganese salt dissolved in the acid. The purity of manganese salt in the manganese salt solution relative to other metals may be about 50 wt. % to about 100 wt. % of the total manganese in the leach solution (e.g., about 70 wt. % to about 99 wt. %, about 80 wt. % to about 99 wt. %, about 95 wt. % to about 98 wt. %). For example, the acid may be sulfuric acid forming a manganese sulfate solution.

In step 170, the leach solution is contacted with a cobalt-selective extractant to extract cobalt from the leach solution. Prior to step 170, the pH of the leach solution may be adjusted to a pH at which the cobalt-selective extractant is more selective for cobalt extraction by adding a base (e.g., about 0.5 M to about 1.0 M NaOH). For example, the pH may be adjusted to be about 2.5 to about 3.5 (e.g., about 2.8 to about 3.2, or about 3). In some embodiments, the pH may be about 2 to about 3 to substantially reduce co-extraction of nickel. The cobalt-selective extractant may be dissolved or dispersed in a non-polar solvent and the leach solution is in an aqueous phase. Thus, when the leach solution is contacted with the cobalt-selective extractant in the non-polar solvent, cobalt ions from the leach solution move into the non-polar phase.

The amount of cobalt from the leach solution moved to the non-polar phase may be about 50 wt. % to about 100 wt. % of the total cobalt in the leach solution (e.g., about 70 wt. % to about 99 wt. %, about 80 wt. % to about 98 wt. %, about 90 wt. % to about 95 wt. %, or about 95 wt. %). After this step, the leach solution may be substantially free of cobalt (e.g., less than about 10 wt. %, less than about 5 wt. %, less than about 2 wt. %, less than about 1 wt. %, less than about 0.5 wt. %, less than about 0.1 wt. %, or less than about 0.01 wt. %).

The cobalt-selective extractant may include saponified bis(2,4,4-trimethylpentyl)phosphinic acid (Na-CYANEX 272). Nonlimiting examples of the non-polar solvent may include kerosene, dichloromethane, toluene, heptane, hexane, octane, cyclohexanone, cyclohexane, or a combination of two or more thereof. For example, the cobalt-selective extractant may be 20% v/v Na-CYANEX 272 in kerosene.

After extraction, the non-polar phase, including the cobalt-selective extractant, cobalt ions, and non-polar solvent, may be separated from the leach solution. Separation may be conducted via membrane separation, separatory funnel, or a mixer/settler. In any embodiment, membrane separation may be used to separate the non-polar and polar phases, as disclosed herein.

After extracting the cobalt into the non-polar phase, the non-polar phase may be contacted with an acid solution (e.g., sulfuric acid, hydrochloric acid, nitric acid, or a combination of any two or more thereof), forming a cobalt salt dissolved in the acid. The purity of cobalt salt in the cobalt salt solution as compared to other metals in the solution may be about 50 wt. % to about 100 wt. % (e.g., about 70 wt. % to about 99 wt. %, about 80 wt. % to about 99 wt. %, about 95 wt. % to about 98 wt. %). For example, the acid may be sulfuric acid, forming a cobalt sulfate solution.

In step 180, the leach solution is contacted with a nickel-selective extractant to extract nickel from the leach solution. Prior to step 180, the pH of the leach solution may be adjusted to a pH at which the nickel-selective extractant is more selective for nickel extraction by adding a base (e.g., about 0.5 M to about 1.0 M NaOH). For example, the pH may be adjusted to be about 5 to about 6.5 (e.g., about 6.0 to about 6.5, or about 6.5). The nickel-selective extractant may be dissolved or dispersed in a non-polar solvent and the leach solution is in an aqueous phase. Thus, when the leach solution is contacted with the nickel-selective extractant in the non-polar solvent, nickel ions from the leach solution move into the non-polar phase.

The amount of nickel from the leach solution moved to the non-polar phase may be about 50 wt. % to about 100 wt. % of the total nickel in the leach solution (e.g., about 70 wt. % to about 99 wt. %, about 80 wt. % to about 98 wt. %, about 90 wt. % to about 95 wt. %, or about 95 wt. %). After this step, the leach solution may be substantially free of nickel (e.g., less than about 10 wt. %, less than about 5 wt. %, less than about 2 wt. %, less than about 1 wt. %, less than about 0.5 wt. %, less than about 0.1 wt. %, or less than about 0.01 wt. %).

The nickel-selective extractant may include di(2-ethylhexyl)phosphoric acid, sulfanyl-sulfanylidene-bis[(2R)-2,4,4-trimethylpentyl]-15-phosphane, or a combination of two or more thereof. Nonlimiting examples of the non-polar solvent may include kerosene, dichloromethane, toluene, heptane, hexane, octane, cyclohexanone, cyclohexane, or a combination of two or more thereof. For example, the nickel-selective extractant may be 20% v/v di(2-ethylhexyl)phosphoric acid in kerosene.

The non-polar phase, including the nickel-selective extractant, nickel ions, and non-polar solvent, may be separated from the leach solution. Separation may be conducted via membrane separation, separatory funnel, or a mixer/settler. In any embodiment, membrane separation may be used to separate the non-polar and aqueous phases.

After extracting the nickel into the non-polar phase, the non-polar phase may be contacted with an acid solution (e.g., sulfuric acid, hydrochloric acid, nitric acid, or a combination of any two or more thereof), forming a nickel salt dissolved in the acid. The purity of nickel salt in the nickel salt solution relative to other metals in the solution may be about 50 wt. % to about 100 wt. % of the total nickel in the leach solution (e.g., about 70 wt. % to about 99 wt. %, about 80 wt. % to about 99 wt. %, about 95 wt. % to about 98 wt. %). For example, the acid may be sulfuric acid, forming a nickel sulfate solution.

Membrane separation of aqueous and non-polar phases may include using a microporous membrane. The membrane may be hydrophobic or hydrophilic, where the hydrophobic membrane is permeable to the non-polar phase and where the hydrophilic membrane is permeable to the aqueous phase. For example, the membrane may be hydrophilic, providing permeability to the aqueous phase but not the non-polar phase. As another example, the membrane may be hydrophobic, providing permeability to the non-polar phase but not the aqueous phase. The membrane may be formed of polymer (e.g., polytetrafluoroethylene (PTFE), polyvinylidene fluoride (PVDF), or sulfonated tetrafluoroethylene based fluoropolymer-copolymer) or ceramic (e.g., anodic alumina or glass). Systems 200 and 300 as described herein include hydrophobic membranes. Systems may instead use hydrophilic membranes where components of the aqueous phases described herein are instead dispersed or dissolved in the non-polar phases, and the components of the non-polar phases described herein are instead dispersed or dissolved in the aqueous phases.

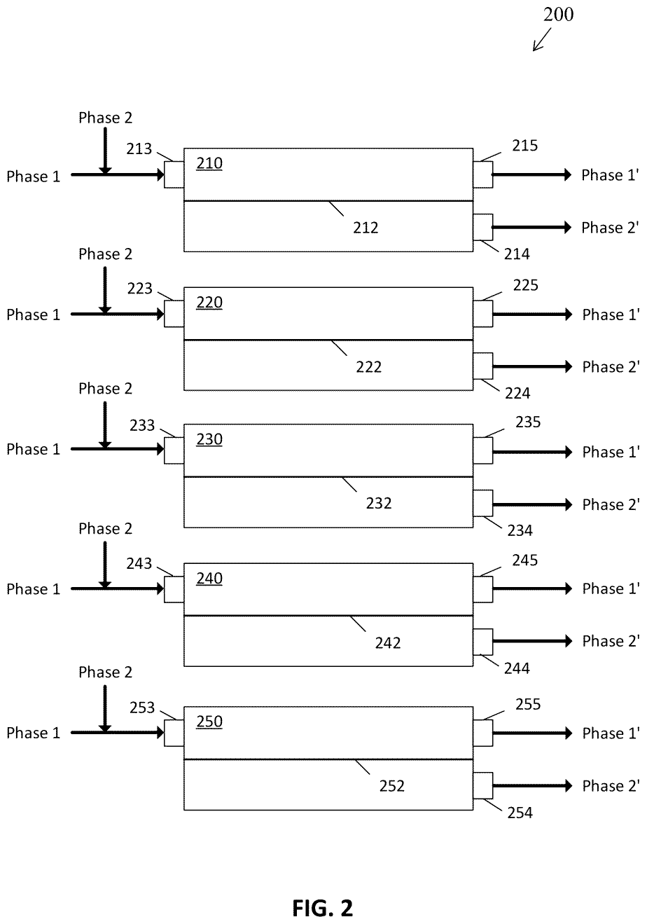

FIG. 2 is an illustration of a system 200 including multiple stages of counter-flow separation of aqueous and non-polar phases. Each stage includes a membrane. The system 200 may include a stage for separation of each metal extracted from the black mass.

In particular, stage 210 extracts lithium ions from the lithium leach solution formed by leaching lithium from black mass with the first acid solution. Stage 210 includes a membrane 212 permeable to phase 2 but not phase 1. Prior to entering stage 210, phase 1 (i.e., the aqueous lithium leach solution) is mixed with phase 2 (i.e., the non-polar phase including the lithium-selective extractant). Upon mixing, lithium ions from the leach solution are extracted into phase 2 from phase 1, forming a mixture of phase 1′ (i.e., the leach solution with reduced or remove lithium ions) and phase 2′ (i.e., the non-polar phase with lithium-selective extractant and lithium ions). The mixture of phase 1′ and phase 2′ flow into stage 210 via port 213. Because the membrane 212 is permeable to phase 2′, phase 2′ permeates the membrane 212 and flows out of stage 210 via port 214. Phase 1′ is unable to permeate the membrane 212 and flows out of stage 210 via port 215, thereby separating phase 1′ and phase 2′. After flowing through stage 210, phase 2′, including lithium ions, may be collected and/or subjected to contact with an additional acid to form an aqueous lithium salt solution, as described herein.

Stage 220 extracts copper ions from the mixed metal leach solution formed by leaching metals from black mass with the second acid solution. Stage 220 includes a membrane 222 permeable to phase 2 but not phase 1. Prior to entering stage 220, phase 1 (i.e., the aqueous mixed metal leach solution) is mixed with phase 2 (i.e., the non-polar phase including the copper-selective extractant). Upon mixing, copper ions from the leach solution are extracted from phase 1 into phase 2, forming a mixture of phase 1′ (i.e., the leach solution with reduced or remove copper ions) and phase 2′ (i.e., the non-polar phase with copper-selective extractant and copper ions). The mixture of phase 1′ and phase 2′ flow into stage 220 via port 223. Because the membrane 222 is permeable to phase 2′, phase 2′ permeates the membrane 222 and flows out of stage 220 via port 224. Phase 1′ is unable to permeate the membrane 222 and flows out of stage 220 via port 225, thereby separating phase 1′ and phase 2′. After flowing through stage 220, phase 2′, including copper ions, may be collected and/or subjected to contact with an additional acid to form an aqueous copper salt solution, as described herein.

Stage 230 extracts manganese ions from the mixed metal leach solution following extraction of copper ions in stage 220. Stage 230 includes a membrane 232 permeable to phase 2 but not phase 1. Prior to entering stage 230, phase 1 (i.e., the aqueous mixed metal leach solution after copper extraction) is mixed with phase 2 (i.e., the non-polar phase including the manganese-selective extractant). Upon mixing, manganese ions from the leach solution are extracted from phase 1 into phase 2, forming a mixture of phase 1′ (i.e., the leach solution with reduced or remove manganese ions) and phase 2′ (i.e., the non-polar phase with manganese-selective extractant and manganese ions). The mixture of phase 1′ and phase 2′ flow into stage 230 via port 233. Because the membrane 232 is permeable to phase 2′, phase 2′ permeates the membrane 232 and flows out of stage 230 via port 234. Phase 1′ is unable to permeate the membrane 232 and flows out of stage 230 via port 235, thereby separating phase 1′ and phase 2′. After flowing through stage 230, phase 2′, including manganese ions, may be collected and/or subjected to contact with an additional acid solution to form an aqueous manganese salt solution, as described herein.

Stage 240 extracts cobalt ions from the mixed metal leach solution following extraction of copper ions and manganese ions in stage 220 and stage 230, respectively. Stage 240 includes a membrane 242 permeable to phase 2 but not phase 1. Prior to entering stage 240, phase 1 (i.e., the leach solution after copper and manganese extraction) is mixed with phase 2 (i.e., the non-polar phase including the cobalt-selective extractant). Upon mixing, cobalt ions from the leach solution are extracted from phase 1 into phase 2, forming a mixture of phase 1′ (i.e., the leach solution with reduced or remove cobalt ions) and phase 2′ (i.e., the non-polar phase with cobalt-selective extractant and cobalt ions). The mixture of phase 1′ and phase 2′ flow into stage 240 via port 243. Because the membrane 242 is permeable to phase 2′, phase 2′ permeates the membrane 242 and flows out of stage 240 via port 244. Phase 1′ is unable to permeate the membrane 242 and flows out of stage 240 via port 245, thereby separating phase 1′ and phase 2′. After flowing through stage 240, phase 2′, including cobalt ions, may be collected and/or subjected to contact with an additional acid solution to form an aqueous cobalt salt solution, as described herein.

Stage 250 extracts nickel ions from the mixed metal leach solution following extraction of copper ions, manganese ions, and cobalt ions in stage 220, stage 230, and stage 240, respectively. Stage 250 includes a membrane 252 permeable to phase 2 but not phase 1. Prior to entering stage 250, phase 1 (i.e., the leach solution after copper, manganese, and cobalt extraction) is mixed with phase 2 (i.e., the non-polar phase including the nickel-selective extractant). Upon mixing, nickel ions from the leach solution are extracted from phase 1 into phase 2, forming a mixture of phase 1′ (i.e., the leach solution with reduced or remove nickel ions) and phase 2′ (i.e., the non-polar phase with nickel-selective extractant and nickel ions). The mixture of phase 1′ and phase 2′ flow into stage 250 via port 253. Because the membrane 252 is permeable to phase 2′, phase 2′ permeates the membrane 252 and flows out of stage 250 via port 254. Phase 1′ is unable to permeate the membrane 252 and flows out of stage 250 via port 255, thereby separating phase 1′ and phase 2′. After flowing through stage 250, phase 2′, including nickel ions, may be collected and/or subjected to contact with an additional acid solution treatment to form an aqueous nickel salt solution, as described herein.

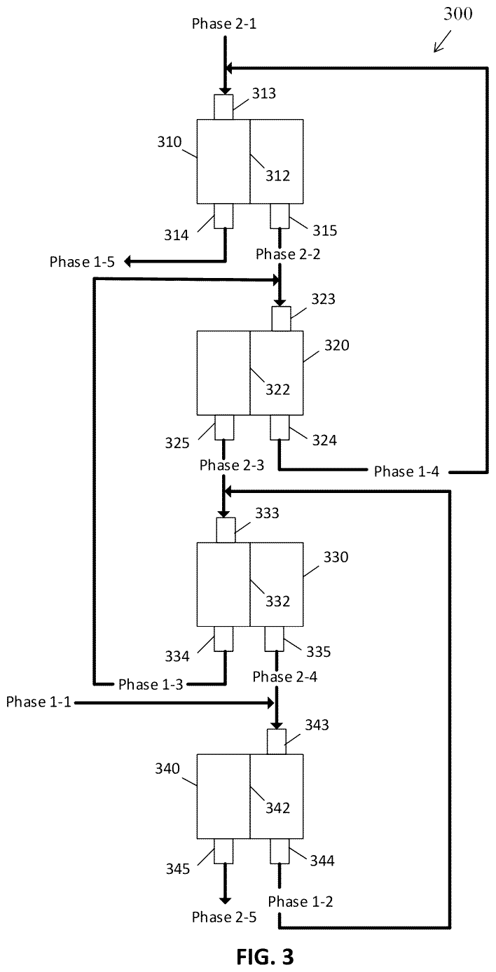

FIG. 3 is an illustration of a schematic of a continuous counterflow membrane separation system 300 used to separate metals from lithium-ion battery materials. Stages 310, 320, 330, and 340 include hydrophobic membranes 312, 322, 332, and 342, respectively, each of which is permeable to phase 2 (i.e., the non-polar phase) but not phase 1 (i.e., the aqueous phase). The counterflow configuration of system 300 provides efficient extraction and separation of different metals from the mixed metal leachate.

Phase 1-1 in system 300 is an aqueous phase comprising the mixed metal leachate. Phase 1-2 is the aqueous phase comprising the mixed metal leachate with reduced or removed copper ions. Phase 1-3 is the aqueous phase comprising the mixed metal leachate with reduced or removed copper and manganese ions. Phase 1-4 is the aqueous phase comprising the mixed metal leachate with reduced or removed copper, manganese, and cobalt ions. Phase 1-5 is the aqueous phase comprising the mixed metal leachate with reduced or removed copper, manganese, cobalt, and nickel ions.

Phase 2-1 in system 300 is a non-polar phase comprising the copper-selective extractant, the manganese-selective extractant, the cobalt-selective extractant, and the nickel-selective extractant in the non-polar solvent. Phase 2-2 is the non-polar phase comprising nickel ions, the copper-selective extractant, the manganese-selective extractant, the cobalt-selective extractant, and the nickel-selective extractant. Phase 2-3 is the non-polar phase comprising nickel ions, cobalt ions, the copper-selective extractant, the manganese-selective extractant, the cobalt-selective extractant, and the nickel-selective extractant. Phase 2-4 is the non-polar phase comprising nickel ions, cobalt ions, manganese ions, the copper-selective extractant, the manganese-selective extractant, the cobalt-selective extractant, and the nickel-selective extractant. Phase 2-5 is the non-polar phase comprising nickel ions, cobalt ions, manganese ions, copper ions, the copper-selective extractant, the manganese-selective extractant, the cobalt-selective extractant, and the nickel-selective extractant.

In system 300, phase 1-1 mixes with phase 2-4, forming phase 2-5 and phase 1-2. Phase 2-5 and 1-2 enter stage 340 via inlet 343, and phase 2-5 crosses membrane 342 and exits stage 340 via outlet 345.

Phase 1-2 exits stage 340 via outlet 344, and then phase 1-2 is mixed with phase 2-3, forming phase 1-3 and phase 2-4. Phase 1-3 and phase 2-4 enter stage 330 via inlet 333, and phase 2-4 crosses membrane 332 and exits stage 330 via outlet 335.

Phase 1-3 exits stage 330 via outlet 334, and then phase 1-3 is mixed with phase 2-2, forming phase 1-4 and phase 2-3. Phase 1-4 and phase 2-3 enter stage 320 via inlet 323, and phase 2-3 crosses membrane 322 and exits stage 320 via outlet 325.

Phase 1-4 exits stage 330 via outlet 334, and then phase 1-4 is mixed with phase 2-1, forming phase 1-5 and phase 2-2. Phase 1-5 and phase 2-2 enter stage 310 via inlet 313, and phase 2-2 crosses membrane 312 and exits stage 310 via outlet 315. Phase 1-5 exits stage 310 via outlet 314.

A portion or all of phases 2-2, 2-3, 2-4, and 2-5 may be collected and/or subjected to contact with an additional acid solution to form an aqueous metal salt solution, as described herein.

Any step of the processes described herein, and any membrane separation stage of the systems described herein may be skipped, depending on the type of black mass provided. For example, if the black mass does not include cobalt, the cobalt extraction step 170 of the process 100, and stage 240 of the system 200, may be skipped.

While the order of steps of the processes described herein, and separation stages of the systems described herein may be rearranged, the order described herein provides efficient separation of the different metals, particularly where the metal-specific extractants may not adequately discern certain metals from one another.

The methods and systems therefore provide the recovery and separation of substantially separated cobalt, manganese, nickel, and lithium as part of a continuous and scalable recovery process. The method and system can overcome removal limitations caused by equilibrium effects and can recover metal solutions.

The present invention, thus generally described, will be understood more readily by reference to the following examples, which are provided by way of illustration and are not intended to be limiting of the present invention.

### EXAMPLES

### Example 1: Selective Copper Recovery from a Lithium-Ion Battery Material

The MS-10 multi-stage extraction platform used was purchased from Zaiput flow technologies, Waltham Massachusetts, United State. The MS-10 has extraction capabilities with up to 5 stages operated in countercurrent mode. The aqueous solution from one extraction stage was fed into the next extraction stage as the aqueous feed while organic phase was moved in the opposite direction. MS-10 includes SEP-10 units mounting OB-900 hydrophobic membranes and four encased bags with pressure sensors built in. The filters used were 0.5-μm-pore polytetrafluoroethylene (PTFE) membranes (Pall Corporation) and 0.1-μm-pore PTFE laminated membranes (Sterlitech). The choice of the filters was dependent on the interfacial tension. The 0.1-μm-pore diameter membrane was more suitable for low interfacial tension systems. The diaphragm was made of a perfluoroalkoxy (PFA) film. Each stage, including a membrane and diaphragm, separated phases via liquid-liquid extraction, in which the two phases were in intimate contact allowing for solute transfer. Extraction took place inside a capillary according to flow chemistry. The capillary, optimized in terms of length and diameter and wrapped in a loop to minimize space, allowed the two co-injected phases to alternate, forming the slug-flow regime and allowed the surface/volume ratio of the phases to be increased, and therefore the ability to transfer solutes according to the chemical affinities involved. The set up is shown in FIG. 3. Pericyclic pumps delivered both the metal-selective extractant and mixed metal leached solution into the membrane separator, allowing two immiscible phases to be separated based on the interfacial tension between them and the affinity of one of the two phases for a microporous membrane. In other words, through thorough mixing inside the tubing, transfer of ions took place and then the mixture was separated by interfacial tension provided by the diaphragm, where only the phase with the extractant passed through the membrane. Aqueous phase samples were taken at time intervals and analyzed for metal contents using ICP-OES and the extraction efficiency was calculated according to Equation 1.

$$Recovery ( \% ) = \frac{M o - M r}{M o} \times 100 , \qquad Equation l$$

where Mo was the original concentration of a metal in the aqueous solution, Mr was the concentration of the metal in the aqueous solution following extraction.

For instance, 2.0% LIX84 and sulfate leached solution (Cu at a concentration of 125 mg/L, Co at a concentration of 856 mg/L, Ni at a concentration of 1294.5 mg/L, and Mn at a concentration of 556.7 mg/L) flowed counter currently at 1.0 mL/min through the Zaiput-MS-10 system, where phases were mixed via tubing and were controlled by changing the flowrate. The aqueous solution (aqueous phase) and spent extractant (Cu ions plus LIX84) were collected separately. Metal content in the aqueous solution was determined and extraction efficiency was calculated using Equation 1. Stripping of the extracted copper from the spent LIX84 extractant was performed using sulfuric acid solution and stripping efficiency was calculated using Equation 2.

$$Stripping ( \% ) = \frac{M s}{M e} \times 100 , \qquad Equation 2$$

where Ms is concentration of metal in the sulfuric acid solution following stripping and Me is the concentration of metal in the extractant prior to stripping.

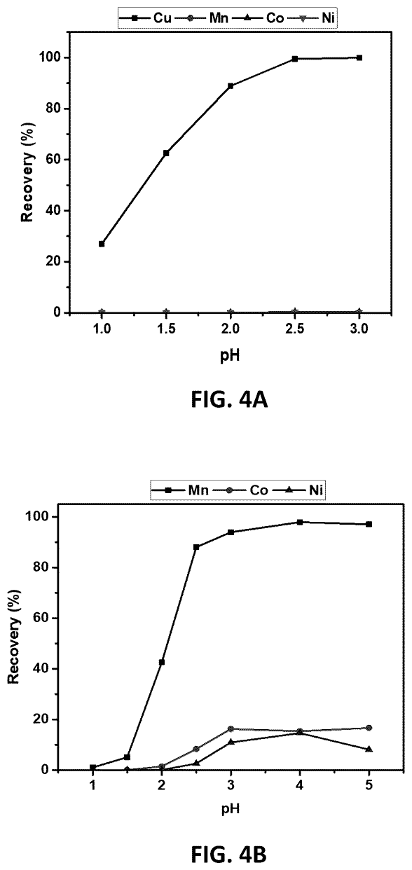

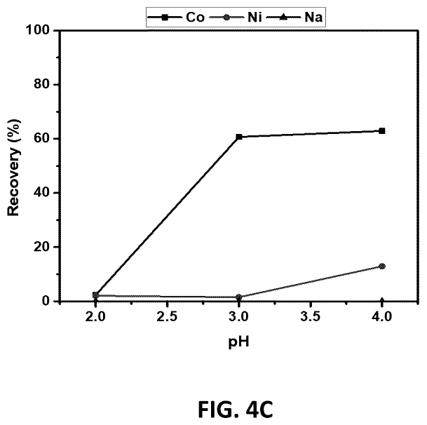

FIG. 4A is a graph of selective copper recovery from a lithium-ion battery material solution using a copper extractant. The solution measured was derived from sequential membrane separation, including leaching black mass with oxalic acid (first acid) to remove lithium, and leaching with sulfuric acid (second acid) to form a second leach solution, then extracting copper from the second leach solution with the copper-selective extractant (2-hydroxy-5-nonylbenzophenone oxime (LIX84)), and treating the non-polar extraction phase with 1.0 M sulfuric acid to form a copper sulfate solution, as described herein.

The graph in FIG. 4A compares copper concentration in the copper sulfate solution with manganese, cobalt, and nickel concentrations, where copper extraction was conducted using leach solutions with different pH. As shown, copper extraction was completely selective for copper over the other metals in a pH range of 1 to 3.

### Example 2: Selective Manganese Recovery from a Lithium-Ion Battery Material

FIG. 4B is a graph of pH-dependent selective manganese recovery from a lithium-ion battery material solution using a manganese extractant. The solution measured was derived from the sequential membrane separation described in Example 1. Following copper extraction, the leach solution was subjected to manganese extraction with a manganese-selective extractant (di(2-ethylhexyl)phosphoric acid), and then treatment of the resulting non-polar phase with 0.5 M sulfuric acid to form a manganese sulfate solution.

The graph in FIG. 4B compares manganese concentration in the manganese sulfate solution with cobalt and nickel concentrations using inductively coupled plasma mass spectroscopy (ICP-MS). Extraction of manganese was conducted using leach solutions with different pH. As shown, more manganese is extracted at pH of 2.5 to 5, however lesser amounts of cobalt and nickel are also extracted at higher pHs.

### Example 3: Selective Cobalt Recovery from a Lithium-Ion Battery Material

FIG. 4C is a graph of pH-dependent cobalt recovery from a lithium-ion battery material solution using a cobalt extractant. The solution measured was derived from the sequential membrane separation described in Examples 1 and 2. Following copper extraction and manganese extraction, the leach solution was subjected to cobalt extraction with a cobalt-selective extractant (saponified bis(2,4,4-trimethylpentyl)phosphinic acid (Na-CYANEX 272)), and then treatment of the resulting non-polar phase with 1.0 M sulfuric acid to form a cobalt sulfate solution.

The graph in FIG. 4C compares cobalt concentration in the cobalt sulfate solution, with sodium and nickel concentrations, as measured by ICP-MS. Extraction of cobalt was conducted using leach solutions with different pH. As shown, the extraction is more selective for cobalt over nickel at pH of 2 to 3.

### Example 4: Selective Metal Recovery from a Lithium-Ion Battery Material

Table 1 below provides concentrations of different metals in different solutions that are part of sequential metal recovery from lithium-ion black mass, as measured by ICP-MS. The process followed the methods described in Examples 1-3, using manganese extraction at pH 2.5 and cobalt extraction at pH 3.

TABLE 1
Metal content in solutions from sequential metal
extraction process as measured by ICP-MS.

| Solution | Al | Fe | Cu | Mn | Co | Li | Ni | Na | Other |
|---|---|---|---|---|---|---|---|---|---|
| Oxalic acid | 1763.8 | 89.71 | 11.5 | 283.67 | 1.63 | 1246.6 | 11.97 | 203 | |
| leachate (ppm) | | | | | | | | | |
| Sulfate leachate | 30.33 | 5.7 | 268.59 | 776.79 | 834.04 | 96.88 | 2347.8 | 4.22 | |
| (ppm) | | | | | | | | | |
| Manganese | 7.35 | 1.9 | 6.32 | 2146.96 | 97.3 | 3.66 | 6.92 | 3.64 | 0 |
| sulfate (ppm) | | | | | | | | | |
| Cobalt sulfate | 14.02 | 0 | 0 | 9.0 | 3348 | 0 | 142 | 53.1 | 0 |
| (ppm) | | | | | | | | | |
| Nickel sulfate | 9.17 | 1.04 | 1.66 | 0.93 | 76.33 | 0.86 | 6564.4 | 75.2 | 0 |
| (ppm) | | | | | | | | | |

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. A method of separating metals from a battery material, the method comprising:
contacting the battery material with a first acid, forming a first solution comprising lithium from the battery material in the first acid;
separating remaining battery material from the first solution;
contacting the remaining battery material with a second acid, forming a second solution comprising a metal from the remaining battery material;
contacting the second solution with a metal-selective extractant in a non-polar solvent, forming a first non-polar phase comprising the metal, the metal-selective extractant, and the non-polar solvent; and
separating the first non-polar phase from the second solution via a membrane.

2. The method of claim 1, wherein:
the metal comprises copper;
the second solution has a pH of about 0 to about 3;
the metal-selective extractant comprises copper-selective extractant, the copper-selective extractant comprises 2-hydroxy-5-nonylacetophenone oxime, 2-hydroxy-5-nonylacetophenone ketoxime, 5-nonylsalicylaldoxime, or a combination of two or more thereof; and
the method further comprises stripping copper sulfate from the first non-polar phase with sulfuric acid.

3. The method of claim 2, wherein the second solution further comprises manganese, and the method further comprises:
contacting the second solution with a manganese-selective extractant in the non-polar solvent, forming a second non-polar phase comprising manganese, the manganese-selective extractant, and the non-polar solvent; and
separating the second solution from the second non-polar phase.

4. The method of claim 3, further comprising contacting the second non-polar phase with an acid, forming an aqueous manganese salt solution.

5. The method of claim 3, wherein the manganese-selective extractant comprises di(2-ethylhexyl)phosphoric acid sulfanyl-sulfanylidene-bis[(2R)-2,4,4-trimethylpentyl]-λ⁵-phosphane, or a combination thereof.

6. The method of claim 3, wherein the second solution comprises cobalt, and the method further comprises:
contacting the second solution with a cobalt-selective extractant in the non-polar solvent, forming a third non-polar phase comprising cobalt, the cobalt-selective extractant, and the non-polar solvent; and
separating the second solution from the third non-polar phase.

7. The method of claim 6, further contacting the third non-polar phase with an acid, forming a cobalt salt solution.

8. The method of claim 6, wherein the cobalt-selective extractant comprises a saponified bis(2,4,4-trimethylpentyl)phosphinic acid.

9. The method of claim 6, wherein the second solution comprises nickel, and the method further comprises:
adding a base to the second solution to increase pH of the second solution to about 5 to about 6.5;
contacting the second solution with a nickel-selective extractant in the non-polar solvent, forming a fourth non-polar phase comprising nickel and the non-polar solvent; and
separating the second solution from the fourth non-polar phase.

10. The method of claim 9, further comprising contacting the fourth non-polar phase with an acid, forming a nickel salt solution.

11. The method of claim 9, wherein the first solution comprises lithium, and the method further comprises:
contacting the first solution with a lithium-selective extractant in the non-polar solvent, forming a fifth non-polar phase comprising lithium and the non-polar solvent; and
separating the first solution from the fifth non-polar phase.

12. The method of claim 11, further comprising contacting the fifth non-polar phase with an acid, forming a lithium salt solution.

13. The method of claim 1, wherein the second solution comprises cobalt, and the method further comprises:
contacting the second solution with a cobalt-selective extractant in the non-polar solvent, forming a second non-polar phase comprising cobalt and the non-polar solvent; and
separating the second solution from the second non-polar phase.

14. The method of claim 13, further comprising stripping cobalt sulfate from the second non-polar phase with sulfuric acid.

15. The method of claim 1, wherein the first acid comprises oxalic acid.

16. The method of claim 1, wherein the second acid comprises sulfuric acid, hydrochloric acid, citric acid, or nitric acid.

17. The method of claim 1, wherein the non-polar solvent comprises kerosene, dichloromethane, toluene, heptane, hexane, octane, cyclohexanone, cyclohexane, or a combination of two or more thereof.

18. The method of claim 1, wherein the membrane comprises a hydrophobic microporous membrane or a hydrophilic microporous membrane, and the membrane comprises polytetrafluoroethylene membrane (PTFE), polyvinylidene fluoride (PVDF), sulfonated tetrafluoroethylene based fluoropolymer-copolymer, or ceramic.

19. The method of claim 1, wherein the battery material comprises at least a portion of a battery casing, at least a portion of a battery current collector, at least a portion of a battery separator, at least a portion of an anode material, at least a portion of a cathode material, or a combination of any two or more thereof from a spent lithium-ion battery.

20. A method of separating metals from a spent lithium-ion battery material, the method comprising:
dissolving lithium from the spent lithium-ion battery material in oxalic acid to form a first aqueous solution;
extracting lithium from the first aqueous solution into a first non-polar phase;
dissolving copper, manganese, cobalt, and nickel from the spent lithium-ion battery material in sulfuric acid to form a second aqueous solution;
extracting copper from the second aqueous solution into a second non-polar phase;
extracting manganese from the second aqueous solution into a third non-polar phase;
extracting cobalt from the second aqueous solution into a fourth non-polar phase; and
increasing pH of the second aqueous solution to about 6 to about 6.5, extracting the nickel from the second aqueous solution into a fifth non-polar phase.
